(19) United States
(12) Patent Application Publication
(10) Pub. No.: US 2012/0056451 A1
(43) Pub. Date: Mar. 8, 2012

(54) RETRACTABLE HEAD RESTRAINT FOR A VEHICLE SEAT

(75) Inventor: Achim Tscherbner, Ingolstadt (DE)

(73) Assignee: LEAR CORPORATION, Southfield, MI (US)

(21) Appl. No.: 13/196,539

(22) Filed: Aug. 2, 2011

(30) Foreign Application Priority Data
Sep. 3, 2010 (DE) 10 2010 040 225.7

(51) Int. Cl. B60N 2/48; B60N 2/68; B60N 2/20

(52) U.S. Cl. 297/61

(57) ABSTRACT

A vehicle seat includes a bracket for mounting to a vehicle body. A seat back frame is pivotally connected to the bracket for movement between an upright position and a collapsed position. A head restraint is mounted to the seat back frame to translate relative to the frame. A transmission is connected to the bracket, the frame and the head restraint to provide a geared engagement between the head restraint and the bracket such that translation of the head restraint relative to the seat back frame is a direct relationship of a pivotal position of the seat back frame relative to the bracket in order to extend the head restraint at the upright position and to retract the head restraint in the collapsed position.

### CROSS-REFERENCE TO RELATED APPLICATIONS

This application claims foreign priority benefits under 35 U.S.C. §119(a)-(d) to DE 10 2010 040 225.7, filed Sep. 3, 2010, which is hereby incorporated by reference in its entirety.

### TECHNICAL FIELD

Various embodiments relate to vehicle seats having retractable head restraints.

### BACKGROUND

Vehicle seats having retractable head restraints are disclosed in U.S. Pat. No. 6,390,558 B2 to Fischer et al.; and U.S. Pat. No. 7,210,734 B1 to Yetukuri et al.

### BRIEF DESCRIPTION OF THE DRAWINGS

FIG. 1 is a perspective view of a vehicle seat according to an embodiment, illustrated with padding and trim removed for revealing components thereof;

FIG. 2 is an enlarged perspective view of a lower region of a seat back of the vehicle seat of FIG. 1;

FIG. 3 is an enlarged elevation view of a top region of the seat back of the vehicle seat of FIG. 1;

FIG. 4 is an enlarged perspective view of a portion of a transmission of the vehicle seat of FIG. 1; and

FIG. 5 is a front perspective view of the vehicle seat of FIG. 1, illustrated partially collapsed.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

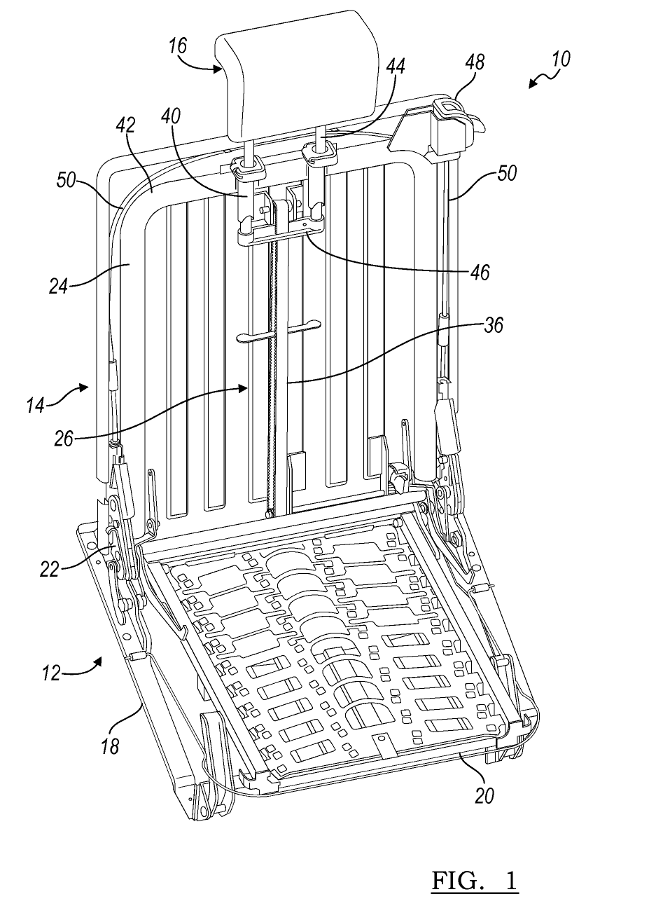

Referring now to FIG. 1, a vehicle seat is illustrated and referenced generally by numeral 10. The vehicle seat 10 may be mounted in a vehicle in any row or orientation and may be utilized as a first row seat, a second row seat, a third row seat, or the like. The vehicle seat 10 may be utilized as a bench seat, a 60/40 seat, or the like. For the depicted embodiment, the vehicle seat 10 includes a seat bottom 12 with a seat back 14 extending therefrom. A head restraint 16 is mounted to a top of the seat back 14. The vehicle seat 10 is collapsible for utilizing the associated seating area for cargo storage, or the like. Accordingly, the seat bottom 12 may be collapsible, or may maintain a seating position. The seat back 14 is collapsible by pivoting towards the seat bottom 12. The head restraint 16 is retractable relative to the seat back 14 to avoid collision with other seats or accessories and to minimize space occupied by the collapsed seat 10.

For the depicted embodiment, the seat bottom 12 includes a pair of rails 18 that are adapted to be mounted to a vehicle floor. The rails 18 support a seat bottom frame 20. A pair of hinge brackets 22 are mounted to the rails 18 and extend upright therefrom. The seat back 14 includes a seat back frame 24 that is pivotally connected to the hinge brackets 22. Alternatively, the hinge brackets 22 could be adapted to be mounted directly to the vehicle floor.

The head restraint 16 is mounted to the seat back frame 24. A transmission 26 is connected to the hinge brackets 22, the seat back frame 24, and the head restraint 16 so that a position of the head restraint 16 relative to the seat back frame 24 is a direct relationship of a pivotal position of the seat back frame 24 relative to the hinge brackets 22. Thus, in an upright position of the seat back 14 as illustrated in FIG. 1, the head restraint 16 is provided in an extended position. Pivoting of the seat back 14 to a collapsed position causes the transmission 26 to retract the head restraint 16.

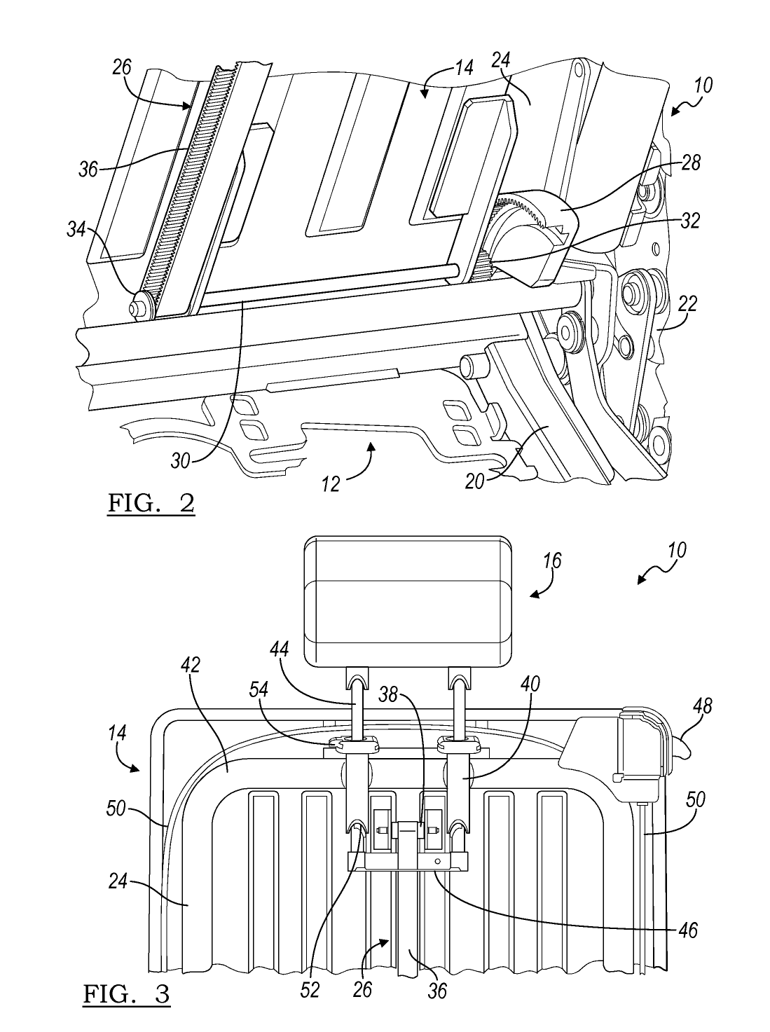

Referring now to FIG. 2, a sector ring gear 28 is mounted to one of the hinge brackets 22. The sector ring gear 28 is static and is generally coaxial with a pivotal connection of the seat back frame 24 to the brackets 22.

A transverse axle 30 is mounted to the seat back frame 24 and is journaled for rotation relative to the seat back frame 24. An input gear 32 is provided on one end of the transverse axle 30 in engagement with the sector ring gear 28. Thus, pivoting of the seat back frame 24 relative to the hinge brackets 22 causes the input gear 32 to travel along the sector ring gear 28. Since the sector ring gear 28 is static, travel of the input gear 32 causes the input gear 32 to rotate thereby rotating the transverse axle 30.

The transverse axle 30 extends to a central region of the seat back frame 24. An output gear 34 is mounted to the end of the transverse axle 30 that terminates in the central region of the seat back frame 24. A toothed belt 36 is connected to the output gear 34.

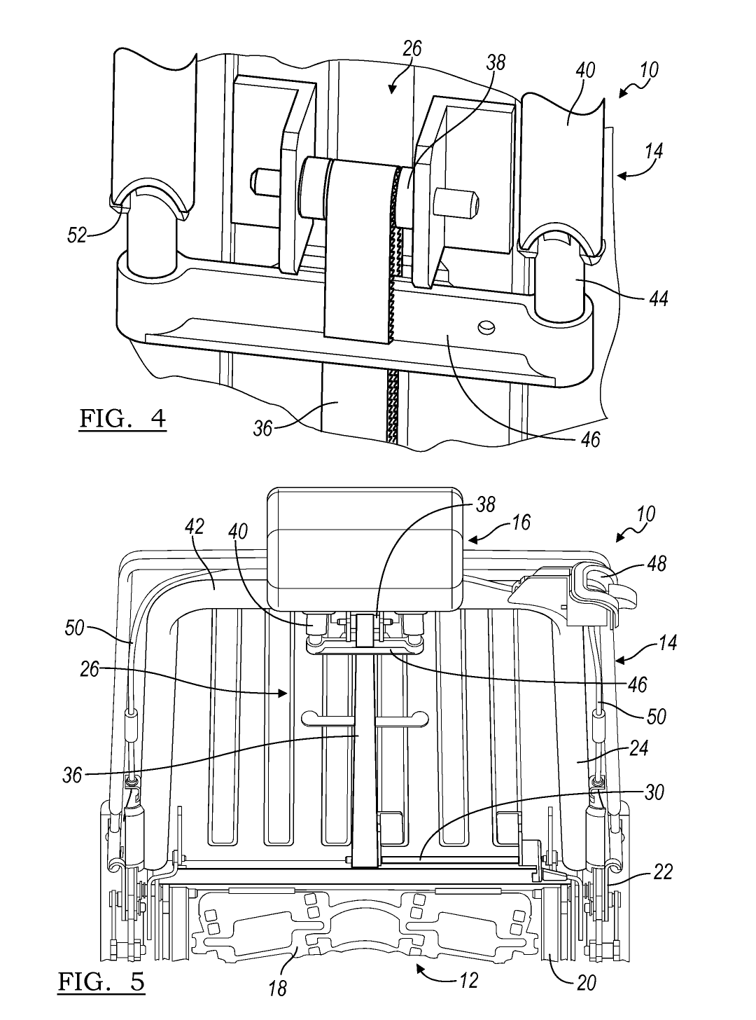

Referring now to FIGS. 3-5, the toothed belt 36 is also supported upon an idler gear 38 that is mounted to the seat back frame 24. The toothed belt 36 is installed under tension to minimize any occurrences of buzz, squeak, or rattle that would otherwise detract from comfort or relaxation of the passenger.

A pair of sleeves 40 are mounted to an upper cross bar 42 of the seat back frame 24 for providing a guide for the head restraint 16. A pair of posts 44 extend from the head restraint 16, through the sleeves 40, and are mounted to a transverse bar 46. The transverse bar 46 is directly attached to the toothed belt 36 on the belt 36. For the depicted embodiment, the transverse bar 46 is illustrated attached to a rearward side of the belt 36. Of course, the transverse bar 46 could be attached to either side of the belt 36. As the seat back 14 is pivoted forward, the input gear 32 is rotated as it travels along the sector ring gear 28 thereby rotating the transverse axle 30 and the output gear 34. The rotation of the output gear 34 drives the toothed belt 36 thereby retracting the transverse bar 46, and consequently the posts 44 and the head restraint 16 for retracting the head restraint 16 relative to the seat back as illustrated partially refracted in FIG. 5. Likewise, pivoting of the seat back frame 24 to the upright position reverses the motion in the transmission 26 thereby extending the head restraint 16.

By providing geared connections throughout the transmission 26, a direct relationship of the head restraint 16 to the seat back frame 24 relative to the pivotal position of the seat back frame 24 to the hinge brackets 22 is provided without any slipping or play that may be associated in cables, pulleys, or the like. Likewise, unwanted noise and vibrations associated with linkages is minimized.

One-handed operation of collapsing the seat back 14 and retracting the head restraint 16 may be provided by merely pivoting the seat back 14. Additionally, a release mechanism 48 may be provided on the seat back frame 24 with cables 50 engaged with latching mechanisms on the hinge brackets 22 so that the user may actuate the release mechanism 48 and pivot the seat back 14, all with a one-handed operation.

Additionally, the extension of the transmission 26 along the seat back frame 24 can add weight to the seat back frame 24. By utilization of the toothed belt 36, a substantial length of the seat back frame 24 is spanned by a relatively lightweight component.

According to an alternative embodiment, independent height adjustment of the head restraint 16 may be provided by providing an additional pair of sleeves 52 within the frame sleeves 40. The second pair of sleeves 52 may be mounted to the transverse bar 46 to be translated by movement of the transverse bar 46. A locking mechanism 54 may be provided on the second sleeves 52 for receiving the head restraint posts 44. Alternatively, the second pair of sleeves 52 may be provided as a bushing for the posts 44 through the frame sleeves 40.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat comprising:
a bracket adapted to be mounted to a vehicle body;
a seat back frame pivotally connected to the bracket for movement between an upright position and a collapsed position;
a head restraint mounted to the seat back frame to translate relative to the seat back frame; and
a transmission connected to the bracket, the seat back frame and the head restraint to provide a geared engagement between the head restraint and the bracket such that translation of the head restraint relative to the seat back frame is a direct relationship of a pivotal position of the seat back frame relative to the bracket in order to extend the head restraint when the seat back frame is at the upright position and to retract the head restraint when the seat back frame is in the collapsed position.

2. The vehicle seat of claim 1 further comprising a seat bottom frame adapted to be mounted to a vehicle body, wherein the bracket is mounted to the seat bottom frame.

3. The vehicle seat of claim 2 wherein the bracket comprises a pair of spaced apart hinge brackets.

4. The vehicle seat of claim 1 wherein the transmission comprises a sector gear mounted to the bracket.

5. The vehicle seat of claim 4 wherein the sector gear comprises a sector ring gear.

6. The vehicle seat of claim 4 wherein the transmission further comprises an input gear mounted for rotation to the seat back frame in engagement with the sector gear such that pivoting of the seat back frame relative to the bracket causes the input gear to rotate as it travels along the sector gear.

7. The vehicle seat of claim 6 wherein the transmission further comprises an output gear driven by the input gear.

8. The vehicle seat of claim 7 wherein the transmission further comprises a toothed belt connected to the output gear.

9. The vehicle seat of claim 8 wherein the toothed belt is under tension.

10. The vehicle seat of claim 8 wherein the head restraint is connected to the toothed belt.

11. The vehicle seat of claim 8 wherein the transmission further comprises an idler gear mounted for rotation to the seat back frame in engagement with the toothed belt for keeping the toothed belt under tension.

12. The vehicle seat of claim 8 further comprising:
a pair of sleeves mounted to the seat back frame; and
a pair of posts mounted in the sleeves to translate in the sleeves, the posts extending from the seat back frame for supporting the head restraint, and the posts being connected to the toothed belt such that the toothed belt drives the posts, and consequently the head restraint, to the extended and refracted positions.

13. The vehicle seat of claim 12 further comprising a transverse bar mounted to the toothed belt and connected to the pair of posts.

14. The vehicle seat of claim 13 further comprising:
a second pair of sleeves extending from the transverse bar, the second pair of sleeves extending through the sleeves of the seat back frame, the second pair of sleeves receiving the pair of posts; and
a locking mechanism provided on the second pair of sleeves for permitting adjustment of the pair of posts relative to the second pair of sleeves.

15. A vehicle seat comprising:
a bracket adapted to be mounted to a vehicle body;
a seat back frame pivotally connected to the bracket for movement between an upright position and a collapsed position;
a head restraint mounted to the seat back frame to translate relative to the seat back frame; and
a toothed belt operably connected to the bracket, the seat back frame and the head restraint to provide a geared engagement between the head restraint and the bracket such that translation of the head restraint relative to the seat back frame is a direct relationship of a pivotal position of the seat back frame relative to the bracket in order to extend the head restraint when the seat back frame is at the upright position and to retract the head restraint when the seat back frame is in the collapsed position.

16. The vehicle seat of claim 15 further comprising:
a sector gear mounted to the bracket;
an input gear mounted for rotation to the seat back frame in engagement with the sector gear such that pivoting of the seat back frame relative to the bracket causes the input gear to rotate as it travels along the sector gear; and
an output gear driven by the input gear, and in engagement with the toothed belt for driving the toothed belt.

17. The vehicle seat of claim 15 further comprising an idler gear mounted for rotation to the seat back frame in engagement with the toothed belt for keeping the toothed belt under tension.

18. The vehicle seat of claim 15 further comprising:
a pair of sleeves mounted to the seat back frame;
a transverse bar mounted to the toothed belt;
a pair of posts extending from the transverse bar through the sleeves to translate in the sleeves, the posts extending from the seat back frame for supporting the head restraint, such that the toothed belt drives the posts, and consequently the head restraint, to the extended and retracted positions.

19. A vehicle seat comprising:
a bracket adapted to be mounted to a vehicle body;
a sector gear mounted to the bracket;
a seat back frame pivotally connected to the bracket for movement between an upright position and a collapsed position;
an input gear mounted for rotation to the seat back frame in engagement with the sector gear such that pivoting of the seat back frame relative to the bracket causes the input gear to rotate as it travels along the sector gear;
an output gear driven by the input gear;
a toothed belt connected to the output gear;
an idler gear mounted for rotation to the seat back frame in engagement with the toothed belt for keeping the toothed belt under tension; and
a head restraint mounted to the toothed belt and cooperating with the seat back frame to translate relative to the seat back frame such that translation of the head restraint relative to the seat back frame is a direct relationship of a pivotal position of the seat back frame relative to the bracket in order to extend the head restraint when the seat back frame is at the upright position and to retract the head restraint when the seat back frame is in the collapsed position.

20. The vehicle seat of claim 19 further comprising:
a pair of sleeves mounted to the seat back frame; and
a pair of posts mounted in the sleeves to translate in the sleeves, the posts extending from the seat back frame for supporting the head restraint, and the posts being connected to the toothed belt such that the toothed belt drives the posts, and consequently the head restraint, to the extended and retracted positions.
